(19) United States
(12) Patent Application Publication
(10) Pub. No.: US 2019/0138997 A1
(43) Pub. Date: May 9, 2019

(54) Network Competitive Resource Allocation System

(71) Applicant: ADP, LLC, Roseland, NJ (US)

(72) Inventors: James Haas, Bridgewater, NJ (US); Kulsoom Abdullah, Atlanta, GA (US); Manoj Oleti, Hyderabad (IN); Laura Maxwell, Gothenburg (SE); Marc Rind, Summit, NJ (US); Andrew Pierce, Decatur, GA (US)

(21) Appl. No.: 15/804,770

(22) Filed: Nov. 6, 2017

(51) Int. Cl. G06Q 10/10

(52) U.S. Cl. CPC G06Q 10/105

(57) ABSTRACT

A method, computer system, and computer program product for digitally presenting a human resource competitive model for an organization. A computer system identifies organizational data for the organization, including business metrics. The computer system determines a most similar group among a set of flexible comparison groups in each of a set of comparator categories by applying a set of comparison models to the organizational data. The computer system identifies a metrics distribution for the flexible comparison group based on benchmark metrics for a subset of benchmark organizations that has been grouped into the flexible comparison group. The computer system compares the business metrics for the organization to the metrics distribution for the flexible comparison group to determine a human resource competitive model for the organization across a set of business functions. The computer system digitally presents the human resource competitive model for the organization across the set of business functions.

### BACKGROUND INFORMATION

### 1. Field

The present disclosure relates generally to an improved computer system and, in particular, to a method and apparatus for accessing information in a computer system. Still more particularly, the present disclosure relates to a method, system, and computer program product for determining and presenting a potentially competitive resource allocation for an organization.

### 2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance plans, wellness plans, and other programs and organizations using an employee information system. As yet another example, an information system may be used to hire new employees, assign employees to projects, perform reviews for employees, and other suitable operations for the organization. As another example, a research department in the organization may use an information system to store and analyze information to research new products, analyze products, or for other suitable operations.

Currently used information systems include databases. These databases store information about the organization. For example, these databases store information about employees, products, research, product analysis, business plans, and other information about the organization.

Information about the employees may be searched and viewed to perform various operations within an organization. However, this type of information in currently used databases may be cumbersome and difficult to access relevant information in a timely manner that may be useful to performing an operation for the organization. For example, understanding how human resources for an organization compare to other organizations across a number of business metrics may be desirable for operations such as identifying new hires, selecting teams for projects, and other operations in the organization. However, because specific descriptions of relevant human resource information may vary among different organizations, accurate comparisons often cannot be determined. Therefore, relevant information is often excluded from the analysis and performance of the operation. Furthermore, identifying appropriate human resource information for companies of a particular size and industry may take more time than desired in an information system.

Therefore, it would be desirable to have a method and apparatus that take into account at least some of the issues discussed above, as well as other possible issues. For example, it would be desirable to have a method and apparatus that overcome the technical problem of presenting a potentially competitive resource allocation for an organization.

### SUMMARY

An embodiment of the present disclosure provides a method for digitally presenting a potentially competitive resource allocation for an organization. A computer system identifies organizational data for the organization. The organizational data includes business metrics for the organization. The computer system determines a most similar group among a set of flexible comparison groups for the organization in each of a set of comparator categories by applying a set of comparison models to the organizational data. Each of the set of comparator categories comprises a set of flexible comparison groups. The computer system identifies a metrics distribution for the flexible comparison group based on benchmark metrics for a subset of benchmark organizations. The subset of benchmark organizations has been grouped into the flexible comparison group. The computer system compares the business metrics for the organization to the metrics distribution for the flexible comparison group to determine a human resource competitive model for the organization across a set of business functions. The computer system then digitally presents the human resource competitive model for the organization across a set of business functions.

Another embodiment of the present disclosure provides a computer system comprising a display system and a human resource modeler in communication with the display system. The human resource modeler is configured to identify organizational data for the organization. The organizational data includes business metrics for the organization. The human resource modeler is further configured to determine a most similar group among a set of flexible comparison groups for the organization in each of a set of comparator categories by applying a set of comparison models to the organizational data. Each of the set of comparator categories comprises a set of flexible comparison groups. The human resource modeler is further configured to identify a metrics distribution for the flexible comparison group based on benchmark metrics for a subset of benchmark organizations. The subset of benchmark organizations has been grouped into the flexible comparison group. The human resource modeler is further configured to compare the business metrics for the organization to the metrics distribution for the flexible comparison group to determine a human resource competitive model for the organization across a set of business functions. The human resource modeler is further configured to digitally present the human resource competitive model for the organization across the set of business functions.

Yet another embodiment of the present disclosure provides a computer program product for presenting a potentially competitive resource allocation for an organization. The computer program product comprises a computer readable storage media and program code, stored on the computer readable storage media. The program code includes code for identifying organizational data for the organization, wherein the organizational data includes business metrics for the organization. The program code includes code for determining a most similar group among a set of flexible comparison groups for the organization in each of a set of comparator categories by applying a set of comparison models to the organizational data. Each of the set of comparator categories comprises a set of flexible comparison groups. The program code further includes code for identifying a metrics distribution for the flexible comparison group based on benchmark metrics for a subset of benchmark organizations. The subset of benchmark organizations has been grouped into the flexible comparison group. The program code further includes code for comparing the business metrics for the organization to the metrics distribution for the flexible comparison group to determine a human resource competitive model for the organization across a set of business functions. The program code further includes code for digitally presenting the human resource competitive model for the organization across the set of business functions.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a resource information environment in accordance with an illustrative embodiment;

FIG. 2 is an illustration of a block diagram of a data flow for determining a flexible comparison group for an organization in each of a set of comparator groups categories in accordance with an illustrative embodiment;

FIG. 3 is an illustration of a data flow for determining a talent competitor group in accordance with an illustrative embodiment;

FIG. 4 is an illustration of a data flow for determining a peer group in accordance with an illustrative embodiment;

FIG. 5 is an illustration of a data flow for determining an industry group in accordance with an illustrative embodiment;

FIG. 6 is an illustration of a data flow for determining subsets of benchmark organizations in accordance with an illustrative embodiment;

FIG. 7 is an illustration of a graphical user interface displaying a competitive resource allocation in accordance with an illustrative embodiment;

FIG. 8 is an illustration of a graphical user interface displaying a human resource competitive model in accordance with an illustrative embodiment;

FIG. 9 is an illustration of a graphical user interface displaying metric details of a human resource competitive model in accordance with an illustrative embodiment;

FIG. 10 is an illustration of a flowchart of a process for digitally presenting a human resource competitive model for an organization in accordance with an illustrative embodiment; and

FIG. 11 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that an employer may need information about capital allocation when performing certain operations. Furthermore, identifying appropriate investments into business units for companies of a particular size and industry may also be desirable. The illustrative embodiments also recognize and take into account that searching information systems for successful allocations may be more cumbersome and time-consuming than desirable. For example, because specific responsibilities and descriptions of job positions may vary among different organizations, optimal investment strategies across a business sector often cannot be determined.

The illustrative embodiments also recognize and take into account that digitally presenting a potentially competitive resource allocation for an organization may facilitate accessing information about appropriate investments into business units for companies of a particular size and industry when performing operations for an organization. The illustrative embodiments also recognize and take into account that identifying a potentially competitive resource allocation may still be more difficult than desired.

Thus, the illustrative embodiments provide a method and apparatus for digitally presenting a human resource competitive model for an organization. In one illustrative example, a computer system identifies organizational data for the organization. The organizational data includes business metrics for the organization. The computer system determines a most similar group among a set of flexible comparison groups for the organization in each of a set of comparator categories by applying a set of comparison models to the organizational data. Each of the set of comparator categories comprises a set of flexible comparison groups. The computer system identifies a metrics distribution for the flexible comparison group based on benchmark metrics for a subset of benchmark organizations. The subset of benchmark organizations has been grouped into the flexible comparison group. The computer system compares the business metrics for the organization to the metrics distribution for the flexible comparison group to determine a human resource competitive model for the organization across a set of business functions. The computer system then digitally presents the human resource competitive model for the organization across the set of business functions.

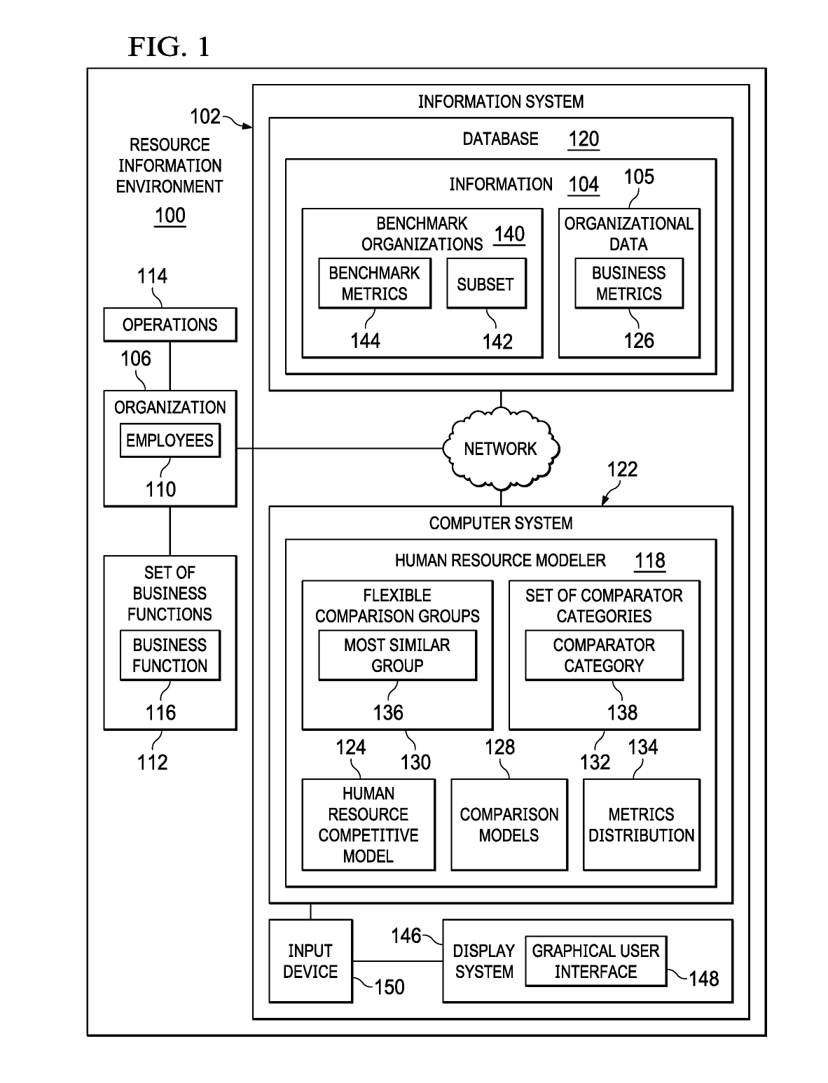

With reference now to the figures and, in particular, with reference to FIG. 1, an illustration of a block diagram of a resource information environment is depicted in accordance with an illustrative embodiment. Resource information environment 100 includes information system 102.

Information system 102 may take different forms. For example, information system 102 may be selected from one of an employee information system, a research information system, a sales information system, an accounting system, a payroll system, a human resources system, or some other type of information system that stores and provides access to information 104 about organization 106.

Information system 102 manages information 104. Information 104 can include organizational data 105 about organization 106. Organizational data 105 may include, for example, at least one of information about people, products, research, product analysis, business plans, financials, or other information relating to organization 106.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Organization 106 may be, for example, a corporation, a partnership, a charitable organization, a city, a government agency, or some other suitable type of organization. As depicted, organization 106 includes employees 110.

As depicted, employees 110 are people who are employed by or associated with organization 106 for which information system 102 is implemented. For example, employees 110 can include at least one of employees, administrators, managers, supervisors, and third parties associated with organization 106. Employees 110 can be current employees or former employees of organization 106.

Organization 106 allocates resources to accomplish one or more of business function 116 in set of business functions 112. As used herein, business function 116 is any activity performed by employees 110 in furtherance of goals of organization 106 or in support of operations 114 of organization 106. As depicted, operations 114 can be an operation of organization 106, such as, but not limited to, at least one of hiring, benefits administration, payroll, performance reviews, forming teams for new products, assigning research projects, or other suitable operations for organization 106. Operations 114 can be performed in furtherance of one or more of business function 116.

In this illustrative example, information system 102 includes different components. As depicted, information system 102 includes human resource modeler 118 and database 120. Human resource modeler 118 and database 120 may be implemented in computer system 122.

Computer system 122 is a physical hardware system that includes one or more data processing systems. When more than one data processing system is present, those data processing systems may be in communication with each other using a communications medium. The communications medium may be a network. The data processing systems may be selected from at least one of a computer, a server computer, a workstation, a tablet computer, a laptop computer, a mobile phone, or some other suitable data processing system.

In this illustrative example, human resource modeler 118 generates human resource competitive model 124. Human resource competitive model 124 is an assessment of the overall human resource health of organization 106 across set of business functions 112 as compared to identified Human Capital Management metrics of other relevant organizations. By generating human resource competitive model 124, human resource modeler 118 enables the performance of operations that may more efficiently support set of business functions 112 of organization 106. For example, human resource competitive model 124 allows organization 106 to perform operations 114 across set of business functions 112 based on identified Human Capital Management metrics of other organizations.

Human resource modeler 118 may be implemented in software, hardware, firmware, or a combination thereof. When software is used, the operations performed by human resource modeler 118 may be implemented in program code configured to run on hardware, such as a processor unit. When firmware is used, the operations performed by human resource modeler 118 may be implemented in program code and data and stored in persistent memory to run on a processor unit. When hardware is employed, the hardware may include circuits that operate to perform the operations in human resource modeler 118.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

In one illustrative example, human resource modeler 118 identifies organizational data 105 for organization 106 within information 104. Organizational data 105 includes business metrics 126 for organization 106. Business metrics 126 are quantifiable measures that track and assess the status of specific business processes or operations, such as operations 114.

In one illustrative example, business metrics 126 are human capital management metrics for organization 106. Human capital management metrics are business metrics 126 that relate to employees 110 of organization 106. Human capital management metrics can include, for example, but not limited to, at least one of attrition metrics, stability and experience metrics, employee equity metrics, organization metrics, workforce metrics, compensation metrics, and other relevant metrics related to human capital management.

Attrition metrics are business metrics 126 that relate to attrition of employees 110. Attrition metrics can include, for example, but not limited to, at least one of a New Hire Turnover Rate metric, a Terminations metric, a Termination Reasons metric, a Hires metric, a Turnover Rate metric, a Retention metric, and other relevant metrics related to the attrition of employees 110.

Stability metrics are business metrics 126 that relate to a stability of employees 110 within organization 106. Stability metrics can include, for example, but not limited to, at least one of a Retirement metric, a Retirement Eligibility metric, an Average Retirement Age metric, a Headcount by Age metric, a Headcount by Generation metric, a Projected Retirement metric, and other relevant metrics related to the stability of employees 110 within organization 106.

Employee equity metrics are business metrics 126 that relate to an equity among employees 110 of organization 106. Employee equity metrics can include, for example, but not limited to, at least one of a Female Percentage metric, an Average Age metric, a Minority Headcount metric, and other relevant metrics related to an equity among employees 110 of organization 106.

Organization metrics are business metrics 126 that relate to a tenure of employees 110 in organization 106. Organization metrics can include, for example, but not limited to, at least one of an Average Time to Promotion metric, a Comp-a-Ratio metric, a Headcount by Tenure metric, an Internal Mobility metric, a Span of Control metric, a Comp-a-Ratio v Performance metric, an Average Tenure metric, and other relevant metrics regarding a tenure of employees 110 in organization 106.

Workforce metrics are business metrics 126 that relate to a workforce status of employees 110 in organization 106. Workforce metrics can include, for example, but not limited to, at least one of a Leave Percentage metric, a Part Time Headcount metric, a Temporary Employee Headcount metric, an Absence metric, an Absences to Overtime metric, a Labor Cost metric, a Leave Hours metric, a Non-Productive Time metric, a Competency Gap metric, a Strongest Weakest Competency metric, and other relevant metrics regarding a workforce status of employees 110 in organization 106.

Compensation metrics are business metrics 126 that relate to a compensation of employees 110 by organization 106. Compensation metrics can include, for example, but not limited to, at least one of an Earnings per Full-Time Employee metric, an Earnings metric, an Overtime Cost metric, an Average Earnings metric, a Benefits Cost metric, a Benefits Enrollment metric, a Benefit Contribution metric, an Overtime Pay metric, and other relevant metrics regarding a compensation of employees 110 by organization 106.

In this illustrative example, human resource modeler 118 can include a number of different components. As used herein, “a number of” is one or more components. As depicted, human resource modeler 118 includes comparison models 128, flexible comparison groups 130, set of comparator categories 132, and metrics distribution 134.

Comparison models 128 are a set of statistical models for correlating organization 106 to one of flexible comparison groups 130. Human resource modeler 118 applies one or more of comparison models 128 to determine most similar group 136 for organization 106 in each of set of comparator categories 132. In this illustrative example, human resource modeler 118 applies one or more of comparison models 128 to organizational data 105 to determine most similar group 136 for comparator category 138.

In this illustrative example, set of comparator categories 132 is a tiered categorical arrangement of benchmark organizations 140. Each of set of comparator categories 132 corresponds to a different set of flexible comparison groups 130. As depicted, comparator category 138 corresponds to flexible comparison groups 130.

In this illustrative example, human resource modeler 118 determines that organization 106 corresponds to most similar group 136 of flexible comparison groups 130 by statistically modeling business metrics 126 using comparison models 128. Comparison models 128 group organization 106 into most similar group 136 corresponding to subset 142 of benchmark organizations 140.

Human resource modeler 118 identifies metrics distribution 134 for most similar group 136. Metrics distribution 134 is statistical aggregation of relevant business metrics based on benchmark metrics 144 for subset 142 of benchmark organizations 140. As depicted, subset 142 of benchmark organizations 140 is an organization having statistically similar business metrics that have been clustered into a common one of flexible comparison groups 130. As depicted, subset 142 of benchmark organizations 140 has been clustered into most similar group 136.

Human resource modeler 118 compares business metrics 126 for organization 106 to metrics distribution 134 for most similar group 136 to determine human resource competitive model 124. Human resource modeler 118 determines human resource competitive model 124 for organization 106 across set of business functions 112.

Set of business functions 112 can include one or more of business function 116. For example, set of business functions 112 can include one or more of an accounting and finance business function, an administration business function, a communications business function, a consulting business function, a human resources business function, an information technology business function, a legal business function, a logistics and distribution business function, a marketing and sales business function, an operations business function, a product development business function, a services business function, and a supports business function.

Business function 116 can be an accounting and finance business function. An accounting and finance business function encompasses accounting, economics, taxation, business laws, and all other fields contributory to the whole process of acquiring and utilizing resources for the benefit of organization 106.

Business function 116 can be an administration business function. An administration business function encompasses the performance or management of business operations and decision-making, as well as the efficient organization of people and other resources to direct activities toward common goals and objectives for organization 106.

Business function 116 can be a communications business function. A communications business function encompasses communications among employees 110 of organization 106. A communications business function can include producing and delivering messages and campaigns on behalf of management, facilitating a two-way dialogue among employees 110 and developing the communication skills of employees 110.

Business function 116 can be a consulting business function. A consulting business function encompasses responsibilities primarily directed to the analysis of existing organizational problems and the development of plans for improvement.

Business function 116 can be a human resources business function. A human resources business function involves operations and responsibilities related to the relationship between organization 106 and employees 110, and supporting and managing the organization's people and associated processes.

Business function 116 can be an information technology business function. An information technology business function involves operations and responsibilities that support technology resources, including computer hardware, software, data, networks, and data center facilities, as well as the maintenance of those resources.

Business function 116 can be a legal business function. A legal business function involves operations and responsibilities that handle legal issues that may arise in the course of business of organization 106.

Business function 116 can be a logistics and distribution business function. A logistics and distribution business function encompasses operations and responsibilities directed to the supply chain flow and storage of goods from the point of origin to the point of consumption, including transportation, shipping, receiving, and storage.

Business function 116 can be a marketing and sales business function. A marketing and sales business function encompasses operations and responsibilities directed towards increasing revenues for organization 106 through the promotion and sale of products and services of organization 106.

Business function 116 can be an operations business function. An operations business function encompasses operations and responsibilities directed to the design and control of processes for producing goods and/or services of organization 106.

Business function 116 can be a product development business function. A product development business function encompasses operations and responsibilities directed to the creation, innovation, and design of products produced by organization 106.

Business function 116 can be a services business function. A services business function encompasses operations and responsibilities directed to interacting with customers of organization 106 regarding inquiries, complaints, and orders.

Business function 116 can be a supports business function. A supports business function encompasses ancillary (supporting) activities carried out by organization 106 in order to permit or facilitate the operation of others of set of business functions 112.

Computer system 122 can display human resource competitive model 124 on display system 146. In this illustrative example, display system 146 can be a group of display devices. A display device in display system 146 may be selected from one of a liquid crystal display (LCD), a light emitting diode (LED) display, an organic light emitting diode (OLED) display, and other suitable types of display devices.

In this illustrative example, human resource competitive model 124 is displayed on display system 146 in graphical user interface 148. An operator may interact with graphical user interface 148 through user input generated by one or more of input device 150, such as, for example, a mouse, a keyboard, a trackball, a touchscreen, a stylus, or some other suitable type of input device 150.

By determining human resource competitive model 124, human resource modeler 118 enables more efficient performance of operations 114 for organization 106 in support of set of business functions 112. For example, operations, such as, but not limited to, at least one of hiring, benefits administration, payroll, performance reviews, forming teams for new products, assigning research projects, or other suitable operations for organization 106 that are performed consistent with human resource competitive model 124 allows organization 106 to perform operations 114 in support of set of business functions 112 based on identified ones of benchmark metrics 144 of relevant ones of benchmark organizations 140.

For example, human resource competitive model 124 allows organization 106 to perform operations 114 in a manner that is consistent with a relevant one of subset 142 of benchmark organizations 140 based on identified ones of benchmark metrics 144 of subset 142. Performing operations 114 in a manner that is consistent with a relevant one of subset 142 may allow organization 106 to achieve business metrics 126 similar to benchmark metrics 144. Additionally, human resource competitive model 124 allows organization 106 to perform operations 114 in a manner that may be inconsistent with a relevant one of subset 142 of benchmark organizations 140 based on identified ones of benchmark metrics 144 of subset 142. Performing operations 114 in a manner that is inconsistent with a relevant one of subset 142 may allow organization 106 to achieve business metrics 126 different from benchmark metrics 144.

In this illustrative example, human resource modeler 118 digitally presents a potential one of human resource competitive model 124 for organization 106. Human resource modeler 118 identifies organizational data 105 for organization 106. Organizational data 105 includes business metrics 126 for organization 106. Human resource modeler 118 determines most similar group 136 for organization 106 in each of set of comparator categories 132 by applying a set of comparison models 128 to organizational data 105. Each of set of comparator categories 132 comprises a set of flexible comparison groups 130. Human resource modeler 118 identifies metrics distribution 134 for most similar group 136 based on benchmark metrics 144 for subset 142 of benchmark organizations 140. Subset 142 of benchmark organizations 140 has been grouped into most similar group 136. Human resource modeler 118 compares business metrics 126 for organization 106 to metrics distribution 134 for most similar group 136 to determine human resource competitive model 124 for organization 106 across set of business functions 112. Human resource modeler 118 digitally presents human resource competitive model 124 for organization 106 across set of business functions 112.

The illustrative example in FIG. 1 and the examples in the other subsequent figures provide one or more technical solutions to overcome a technical problem of determining a competitive allocation of resources for an organization that make the performance of operations for an organization more cumbersome and time-consuming than desired. For example, performing operations 114 in a manner that is consistent with a relevant one of subset 142 may allow organization 106 to achieve business metrics 126 similar to benchmark metrics 144. Additionally, human resource competitive model 124 allows organization 106 to perform operations 114 in a manner that may be inconsistent with a relevant one of subset 142 of benchmark organizations 140 based on identified ones of benchmark metrics 144 of subset 142. Performing operations 114 in a manner that is inconsistent with a relevant one of subset 142 may allow organization 106 to achieve business metrics 126 different from benchmark metrics 144.

In this manner, the use of human resource modeler 118 has a technical effect of determining human resource competitive model 124 based on benchmark metrics 144 of a relevant one of subset 142 of benchmark organizations 140, thereby reducing time, effort, or both in the performance of operations 114 supporting set of business functions 112. In this manner, operations 114 performed for organization 106 may be performed more efficiently as compared to currently used systems that do not include human resource modeler 118. For example, operations 114, such as, but not limited to, at least one of hiring, benefits administration, payroll, performance reviews, forming teams for new products, assigning research projects, or other suitable operations for organization 106 performed in a manner that is consistent with a relevant one of subset 142 may allow organization 106 to achieve business metrics 126 similar to benchmark metrics 144.

As a result, computer system 122 operates as a special purpose computer system in which human resource modeler 118 in computer system 122 enables determining of human resource competitive model 124 from organizational data 105 and benchmark metrics 144 based on one or more of comparison models 128. For example, human resource modeler 118 uses comparison models 128 to cluster benchmark organizations 140 into flexible comparison groups 130 corresponding to set of comparator categories 132. Human resource modeler 118 determines corresponding ones of flexible comparison groups 130 for each comparator category 138 of the set of comparator categories 132 by clustering benchmark organizations 140 into one or more of subset 142 based on benchmark metrics 144 for benchmark organizations 140. Human resource modeler 118 determines metrics distribution 134 based on benchmark metrics 144 of subset 142.

Human resource modeler 118 compares business metrics 126 for organization 106 to metrics distribution 134 to determine the human resource competitive model 124 for organization 106. When human resource competitive model 124 is determined in this manner, human resource competitive model 124 may be relied upon to perform operations 114 for organization 106 in a manner that may allow organization 106 to achieve business metrics 126 similar to benchmark metrics 144.

Thus, human resource modeler 118 transforms computer system 122 into a special purpose computer system as compared to currently available general computer systems that do not have human resource modeler 118. Currently used general computer systems do not reduce the time or effort needed to determine human resource competitive model 124 based on organizational data 105 and benchmark metrics 144 of a relevant one of subset 142 of benchmark organizations 140. Further, currently used general computer systems do not provide for determining human resource competitive model 124 based on comparison models 128.

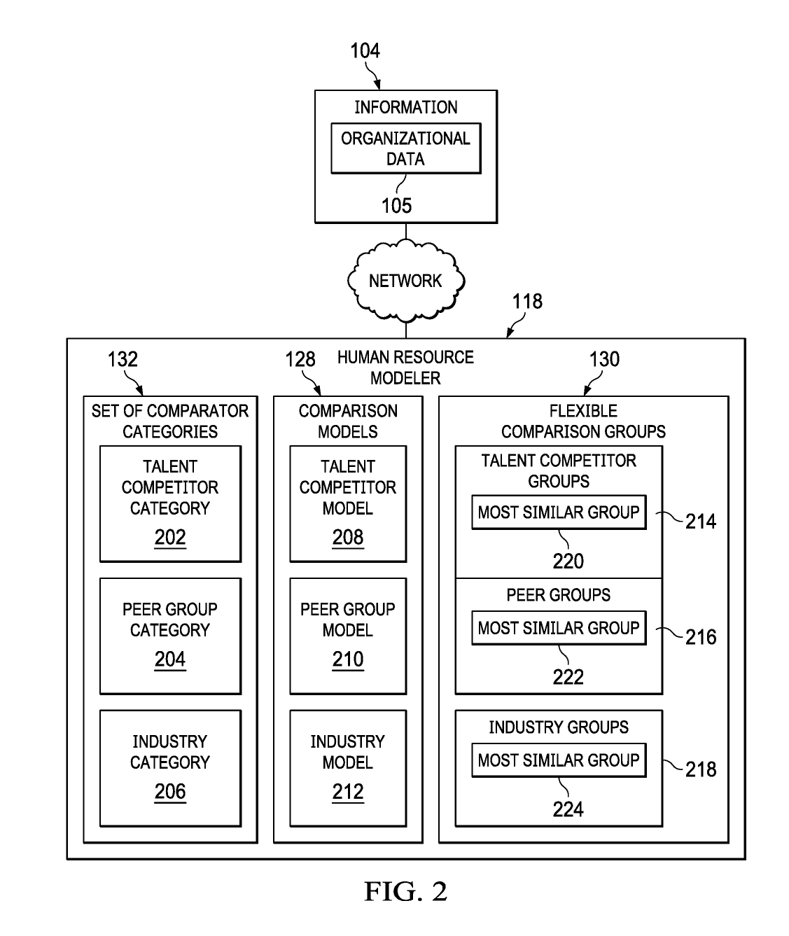

With reference next to FIG. 2, an illustration of a block diagram of a data flow for determining a flexible comparison group for an organization in each of a set of comparator categories is depicted in accordance with an illustrative embodiment. The data flow of FIG. 2 is an illustrative example for determining flexible comparison groups, such as flexible comparison groups 130 shown in block form in FIG. 1.

In this illustrative example, set of comparator categories 132 includes a number of different categories. As depicted, set of comparator categories 132 includes talent competitor category 202, peer group category 204, and industry category 206. In this illustrative example, a user can select between different ones of set of comparator categories 132 by interacting with an appropriate graphical element in a graphical user interface, such as graphical user interface 148, shown in block form in FIG. 1, via an input device, such as input device 150, also shown in block form in FIG. 1.

As depicted, set of comparator categories 132 includes talent competitor category 202. Talent competitor category 202 is a category of organizations, such as benchmark organizations 140, shown in block form in FIG. 1, which tends to acquire employees, such as employees 110, also shown in block form in FIG. 1, from a common pool of candidates.

As depicted, set of comparator categories 132 includes peer group category 204. Peer group category 204 is a category of organizations, such as benchmark organizations 140 of FIG. 1, that have organizational data similar to organizational data 105 shown in block form in FIG. 1, for organization 106, also shown in block form in FIG. 1. The similar organizational data may include, for example, but not limited to, an industry affiliation, job titles, job types, geolocations, as well as other relevant organizational data.

As depicted, set of comparator categories 132 includes industry category 206. Industry category 206 is a category of organizations, such as benchmark organizations 140 of FIG. 1, which has a same industry affiliation as organization 106.

In an illustrative example, a set of comparison models 128 includes a number of different comparison models. As depicted, set of comparison models 128 includes talent competitor model 208, peer group model 210, and industry model 212.

In an illustrative example, flexible comparison groups 130 include a number of different comparison groups. As depicted, flexible comparison groups 130 includes talent competitor groups 214, peer groups 216, and industry groups 218.

In response to the selection of one of set of comparator categories 132, human resource modeler 118 applies a corresponding set of comparison models 128. By applying the set of comparison models 128, human resource modeler 118 determines a most similar group among the corresponding ones of flexible comparison groups 130.

In an illustrative example, in response to a selection of talent competitor category 202, human resource modeler 118 applies talent competitor model 208 to organizational data 105. By applying talent competitor model 208, human resource modeler 118 determines most similar group 220 for organization 106 among talent competitor groups 214.

In an illustrative example, in response to a selection of peer group category 204, human resource modeler 118 applies peer group model 210 to organizational data 105. By applying peer group model 210, human resource modeler 118 determines most similar group 222 for organization 106 among peer groups 216.

In an illustrative example, in response to a selection of industry category 206, human resource modeler 118 applies industry model 212 to organizational data 105. By applying industry model 212, human resource modeler 118 determines most similar group 224 for organization 106 among industry groups 218.

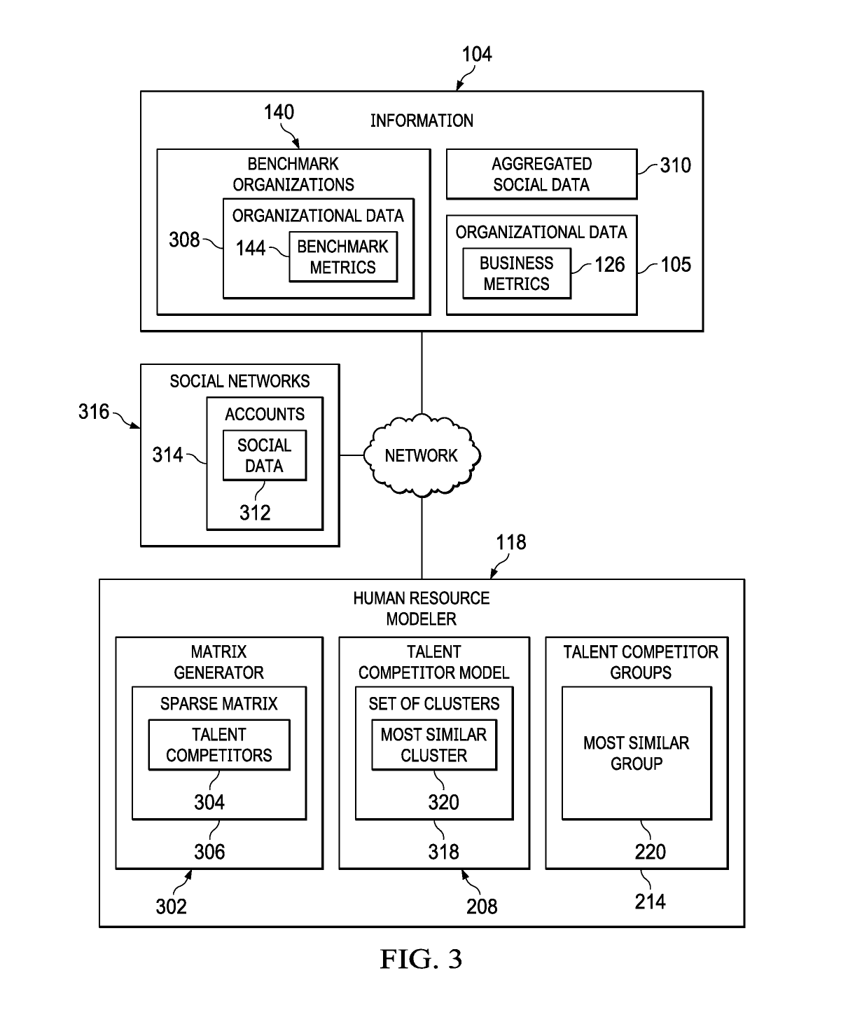

With reference next to FIG. 3, an illustration of a block diagram of a data flow for determining talent competitor groups is depicted in accordance with an illustrative embodiment. As depicted, human resource modeler 118 determines most similar group 220 among talent competitor groups 214 based on a cluster analysis of business metrics 126 and benchmark metrics 144.

As depicted, human resource modeler 118 includes a number of different components. As used herein, “a number of” means one or more different components. As depicted, human resource modeler 118 includes matrix generator 302, talent competitor model 208, and talent competitor groups 214.

Matrix generator 302 determines talent competitors 304 for organization 106 shown in block form in FIG. 1. In this illustrative example, matrix generator 302 determines talent competitors 304 by constructing sparse matrix 306.

In this illustrative example, talent competitors 304 are determined based on movement of employees, such as employees 110 of FIG. 1, among organization 106 and benchmark organizations 140. Movement by employees 110 among organization 106 and benchmark organizations 140 can be determined from organizational data 105, organizational data 308, and aggregated social data 310.

Organizational data 308 is information about benchmark organizations 140. Organizational data 308 may include, for example, at least one of information about people, products, research, product analysis, business plans, financials, or other information relating to benchmark organizations 140.

Aggregated social data 310 is aggregated information about employees 110 determined from social data 312. Social data 312 is data maintained in accounts 314 of employees 110 in social networks 316. Social networks 316 are online services or sites through which people create and maintain interpersonal relationships.

In this illustrative example, social data 312 may indicate one or more of organization 106 and benchmark organizations 140 at which employees 110 are currently employed or have been previously employed. Social data 312 can then be aggregated and stored as aggregated social data 310. Based on movement of employees 110 among organization 106 and benchmark organizations 140 as indicated by aggregated social data 310, matrix generator 302 identifies talent competitors 304 for organization 106.

Human resource modeler 118 uses talent competitor model 208 to cluster talent competitors 304 into set of clusters 318. As depicted, each of set of clusters 318 is a grouping of a subset, such as subset 142, shown in block form in FIG. 1, of talent competitors 304 based on similarities in benchmark metrics 144. Talent competitor model 208 groups talent competitors 304 in such a way that benchmark metrics 144 for talent competitors 304 clustered into a common one of set of clusters 318 are more similar to each other than to benchmark metrics 144 for talent competitors 304 in others of set of clusters 318. In an illustrative example, each of set of clusters 318 can be represented in talent competitor model 208 as a mean vector that represents benchmark metrics 144 for a corresponding one of talent competitors 304. In this illustrative example, each of talent competitors 304 is represented by a corresponding one of set of clusters 318.

Human resource modeler 118 determines most similar group 220 for organization 106 based on a cluster analysis of business metrics 126. In this illustrative example, most similar group 220 corresponds to most similar cluster 320 among set of clusters 318.

In this illustrative example, talent competitor model 208 performs a cluster analysis to compare business metrics 126 with set of clusters 318. Based on the cluster analysis, talent competitor model 208 determines most similar cluster 320 among set of clusters 318.

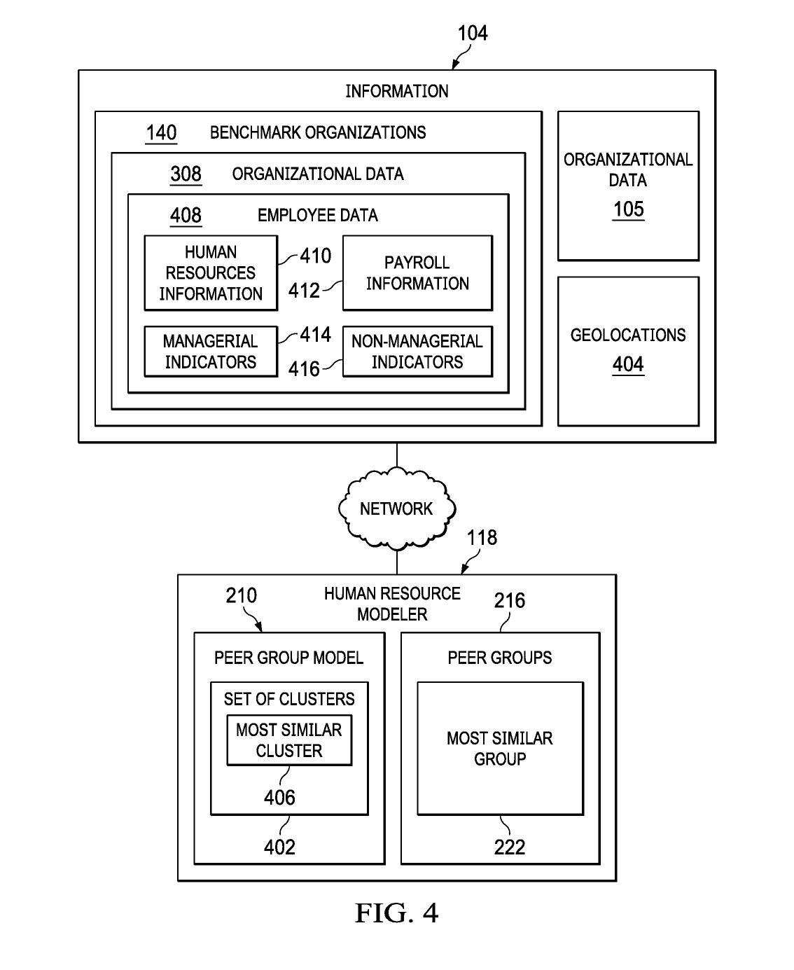

With reference next to FIG. 4, an illustration of a block diagram of a data flow for determining a peer group is depicted in accordance with an illustrative embodiment. As depicted, human resource modeler 118 determines most similar group 222 among peer groups 216 based on a cluster analysis of business metrics 126 and benchmark metrics 144, both shown in block form in FIG. 1.

As depicted, human resource modeler 118 includes a number of different components. As used herein, “a number of” means one or more different components. As depicted, human resource modeler 118 includes peer group model 210 and peer groups 216.

Human resource modeler 118 uses peer group model 210 to cluster benchmark organizations 140 into set of clusters 402. As depicted, each of set of clusters 402 is a grouping of a subset, such as subset 142, shown in block form in FIG. 1, of benchmark organizations 140 based on similarities in organizational data 308 and geolocations 404.

Geolocations 404 are the identifications or estimations of the real-world geographic locations of organization 106 and benchmark organizations 140. Geolocations 404 may be ascertained using a network. For example, geolocations 404 may be identified based on an internet protocol address of transactions sent across the network. The internet protocol address may then be identified within a geolocation database to determine geolocations 404. As listed in the geolocation database, geolocations 404 can include at least one of a country, a region, a city, a zip code, a latitude, a longitude, and a time zone in which organization 106 and benchmark organizations 140 are located.

Peer group model 210 groups benchmark organizations 140 in such a way that organizational data 308 and geolocations 404 for subset 142 of benchmark organizations 140, clustered into a common one of set of clusters 402, are more similar to each other than to organizational data 308 for benchmark organizations 140 in others of set of clusters 402. In an illustrative example, each of set of clusters 402 can be represented in peer group model 210 as a mean vector that represents benchmark metrics 144 for a corresponding one of peer groups 216. In this illustrative example, each of peer groups 216 is represented by a corresponding one of set of clusters 402.

Human resource modeler 118 determines most similar group 222 for organization 106 based on a cluster analysis of organizational data 105. In this illustrative example, most similar group 222 corresponds to most similar cluster 406 among set of clusters 402.

In this illustrative example, employee data 408 includes data about employees 110 in the context of organization 106. Employee data 408 can include information indicative of one or more of set of business functions 112, as shown in block form in FIG. 1.

In this illustrative example, benchmark organizations 140 includes employee data 408. Employee data 408 includes data about employees in the context of benchmark organizations 140. Employee data 408 can include a number of different types of data. For example, employee data 408 can include human resources information 410, payroll information 412, managerial indicators 414, and non-managerial indicators 416.

Human resources information 410 is information in employee data 408 that is indicative of which of set of business functions 112 that the responsibilities of the employees most directly contribute to. Human resources information 410 can include, for example, but not limited to, an Employee Information Report (EEO-1), a Standard Occupational Classification (SOC), a job title, a North American Industry Classification System (NAICS) class, a salary grade, an age, a tenure, as well as other possible information.

Payroll information 412 is information in employee data 408 that is indicative of a compensation of employees. Payroll information 412 can include, for example, but not limited to, an annual base salary, a bonus ratio, an overtime pay, as well as other possible information.

Managerial indicators 414 are information in employee data 408 that indicate a managerial position in benchmark organizations 140. Managerial indicators 414 can include, for example, but not limited to, a specific data entry of a managerial indication, a position in a reporting hierarchy, a Standard Occupational Classification (SOC), a manager level description, and an Employee Information Report (EEO-1).

Non-managerial indicators 416 are information in employee data 408 that indicate a non-managerial position in benchmark organizations 140. Non-managerial indicators 416 can include, for example, but not limited to, a specific data entry of a non-managerial indication, a position in a reporting hierarchy, a non-managerial level description, an Employee Information Report (EEO-1), and a Standard Occupational Classification (SOC).

In this illustrative example, peer group model 210 performs a cluster analysis to compare organizational data 105 with set of clusters 402. Based on the cluster analysis, peer group model 210 determines most similar cluster 406 among set of clusters 402.

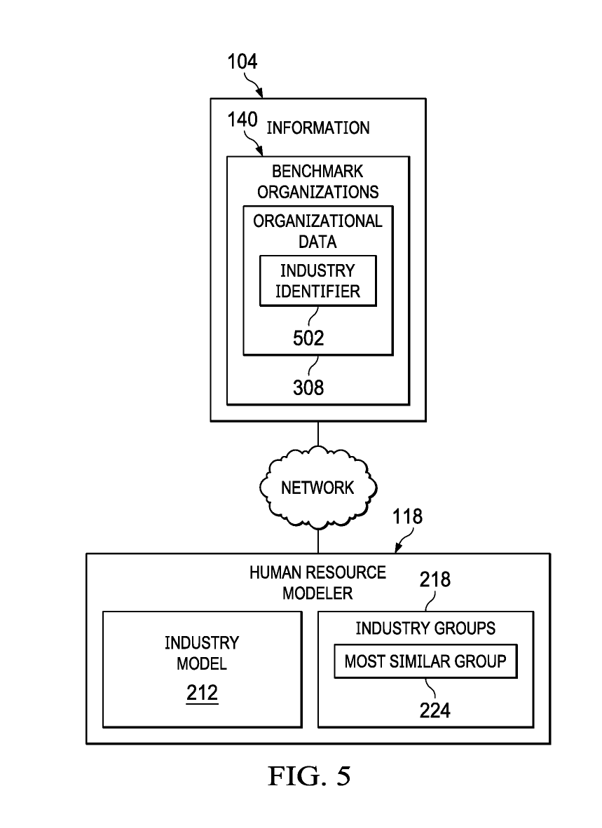

With reference next to FIG. 5, an illustration of a block diagram of a data flow for determining an industry group is depicted in accordance with an illustrative embodiment. As depicted, human resource modeler 118 determines most similar group 224 among industry groups 218 based on a common one of industry identifier 502.

As depicted, human resource modeler 118 includes a number of different components. As used herein, “a number of” means one or more different components. As depicted, human resource modeler 118 includes industry model 212 and industry groups 218.

In this illustrative example, human resource modeler 118 applies industry model 212 to determine most similar group 224 among industry groups 218 for organization 106. Industry model 212 can determine most similar group 224 based on a common one of industry identifier 502 between organization 106 and most similar group 224. In an illustrative example, industry identifier 502 can be at least one of North American Industry Classification System (NAICS) classes for organization 106 and a set of benchmark organizations 140. In this illustrative example, each of industry groups 218 has a common one of industry identifier 502.

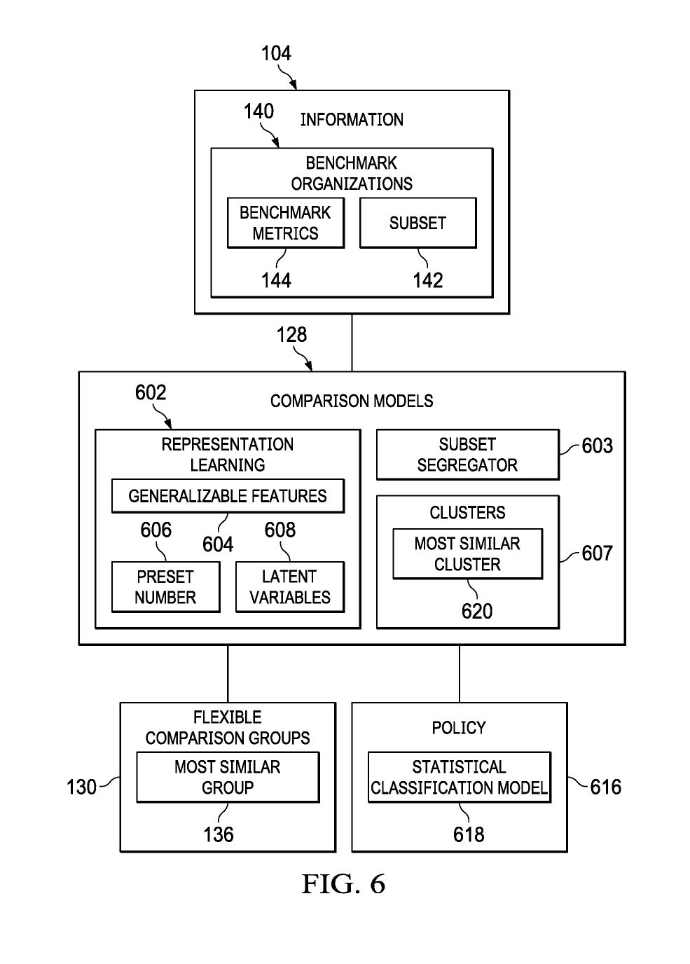

With reference next to FIG. 6, an illustration of a block diagram of a data flow for determining subsets of benchmark organizations is depicted in accordance with an illustrative embodiment. As depicted, human resource modeler 118, shown in block form in FIG. 1, uses comparison models 128 to determine flexible comparison groups 130 for benchmark organizations 140.

As depicted, comparison models 128 of human resource modeler 118 includes a number of different components. As depicted, comparison models 128 include representation learning 602 and subset segregator 603.

Representation learning 602 is a set of techniques that learns generalizable features 604 indicative of a particular one of flexible comparison groups 130 by observing benchmark metrics 144 for benchmark organizations 140.

Generalizable features 604 are variables of compressed data that are inferred from representation learning 602. In this illustrative example, generalizable features 604 are data compressed from benchmark metrics 144 that best explain archetypical features of flexible comparison groups 130, or best distinguishes most similar group 136 from others of flexible comparison groups 130. In this illustrative example, generalizable features 604 may be derived from benchmark metrics 144 by clustering benchmark metrics 144 into preset number 606 of clusters 607.

In this illustrative example, benchmark metrics 144 may be clustered into preset number 606 of clusters 607, wherein preset number 606 corresponds to latent variables 608 used when clustering benchmark metrics 144. In this illustrative example, latent variables 608 can be a list of sequential identifiers applied to each data point in benchmark metrics 144. For example, when preset number 606 of clusters 607 is 13, each of the sequential identifiers may be an integer in the sequence 0, 1, 2, 3, 4, 5, 6, 7, 8, 9, 10, 11, 12.

As depicted, comparison models 128 include subset segregator 603. Subset segregator 603 determines a corresponding one of flexible comparison groups 130 for each of benchmark organizations 140 based on a statistical comparison of benchmark metrics 144 to clusters 607. In this illustrative example, subset segregator 603 determines most similar cluster 620 among clusters 607 for each of benchmark organizations 140 using policy 616. In this illustrative example, policy 616 includes a group of rules that are used to determine corresponding ones of clusters 607 for benchmark organizations 140 represented by benchmark metrics 144.

In this illustrative example, policy 616 includes statistical classification model 618. Statistical classification model 618 is a model for classifying benchmark organizations 140 into a corresponding one of flexible comparison groups 130. Statistical classification model 618 can be, for example, a random forest method model. As illustrated, statistical classification model 618 uses generalizable features 604 to perform statistical comparison of benchmark metrics 144 to clusters 607 clustered from benchmark metrics 144. Human resource modeler 118 can then determine a corresponding one of flexible comparison groups 130 for each of benchmark organizations 140 based on a mode output of statistical classification model 618.

In this manner, human resource modeler 118 determines which of flexible comparison groups 130 that benchmark metrics 144 for each one of benchmark organizations 140 is most similar to, based on modeling of benchmark metrics 144 into a number of clusters 607. Human resource modeler 118 uses generalizable features 604. Human resource modeler 118 determines most similar group 136 for benchmark organizations 140 based on benchmark metrics 144 and generalizable features 604. In this manner, human resource modeler 118 applies representation learning 602 to determine a corresponding one of flexible comparison groups 130 for each one of benchmark organizations 140.

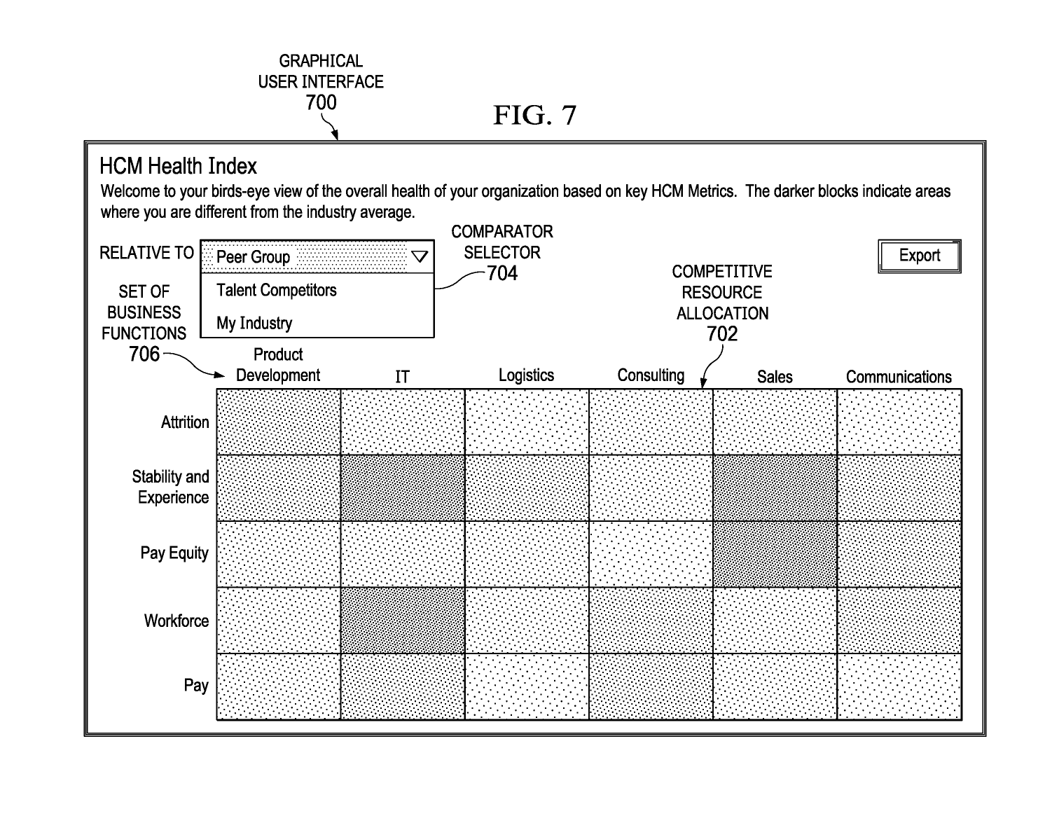

Turning next to FIG. 7, an illustration of a graphical user interface displaying a competitive resource allocation is depicted in accordance with an illustrative embodiment. Graphical user interface 700 displays competitive resource allocation 702. Competitive resource allocation 702 can be digitally presented on a display system, such as display system 146, shown in block form in FIG. 1.

As depicted, graphical user interface 700 includes comparator selector 704. Comparator selector 704 allows a user to select a comparator category from a set of comparator categories, such as set of comparator categories 132, shown in block form in FIG. 1.

As depicted, graphical user interface 700 includes set of business functions 706. Set of business functions 706 is a graphical depiction of set of business functions 112, shown in block form in FIG. 1. As depicted, graphical user interface 700 displays competitive resource allocation 702 across set of business functions 706.

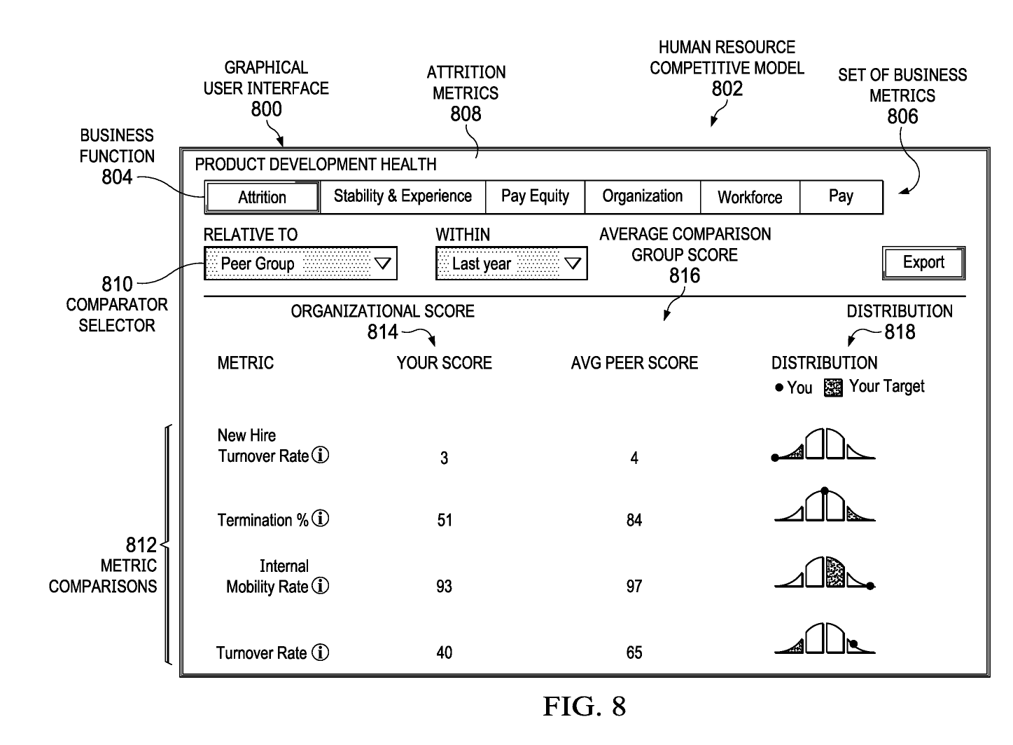

Turning now to FIG. 8, an illustration of a graphical user interface displaying a human resource competitive model is depicted in accordance with an illustrative embodiment. Graphical user interface 800 displays human resource competitive model 802. Human resource competitive model 802 can be digitally presented on a display system, such as display system 146, shown in block form in FIG. 1.

As depicted, human resource competitive model 802 is displayed for business function 804. Business function 804 is an example of business function 116, shown in block form in FIG. 1. In an illustrative example, graphical user interface 800 displays human resource competitive model 802 for business function 804 in response to a selection of a corresponding one of set of business functions 706 from competitive resource allocation 702 of FIG. 7.

Human resource competitive model 802 is displayed across set of business metrics 806. Set of business metrics 806 is an example of business metrics 126 shown in block form in FIG. 1. In this illustrative example, business metrics 806 are human capital management metrics, including attrition metrics, stability and experience metrics, employee equity metrics, organization metrics, workforce metrics, and compensation metrics. In this illustrative example, attrition metrics 808 is selected.

In this illustrative example, human resource competitive model 802 can be displayed across a number of flexible comparison groups, such as flexible comparison groups 130, shown in block form in FIG. 1. As depicted, graphical user interface 800 includes comparator selector 810. Comparator selector 810 allows a user to select a comparator category from a set of comparator categories, such as set of comparator categories 132, shown in block form in FIG. 1. As depicted, comparator selector 810 indicates a selection of “peer group.” In response to a selection of “peer group,” human resource competitive model 802 displays a comparison of set of business metrics 806 between organizations that have similar organizational data, such as organizational data 105 shown in block form in FIG. 1. The similar organizational data may include, for example, but not limited to, an industry affiliation, job titles, job types, geolocations, as well as other relevant organizational data. The comparison can be, for example, the comparison between business metrics 126 of organization 106 and benchmark metrics 144 of most similar group 222, shown in block form in FIG. 2.

In this illustrative example, human resource competitive model 802 includes metric comparisons 812. Metric comparisons 812 are comparisons between specific ones of business metrics 126 of organization 106 and benchmark metrics 144 of most similar group 222. In this illustrative example, metric comparisons 812 are comparisons of attrition metrics, including a new hire turnover rate, a termination percentage, an internal mobility rate, and a turnover rate. In this illustrative example, metric comparisons 812 can include organizational score 814, average comparison group score 816, and distribution 818.

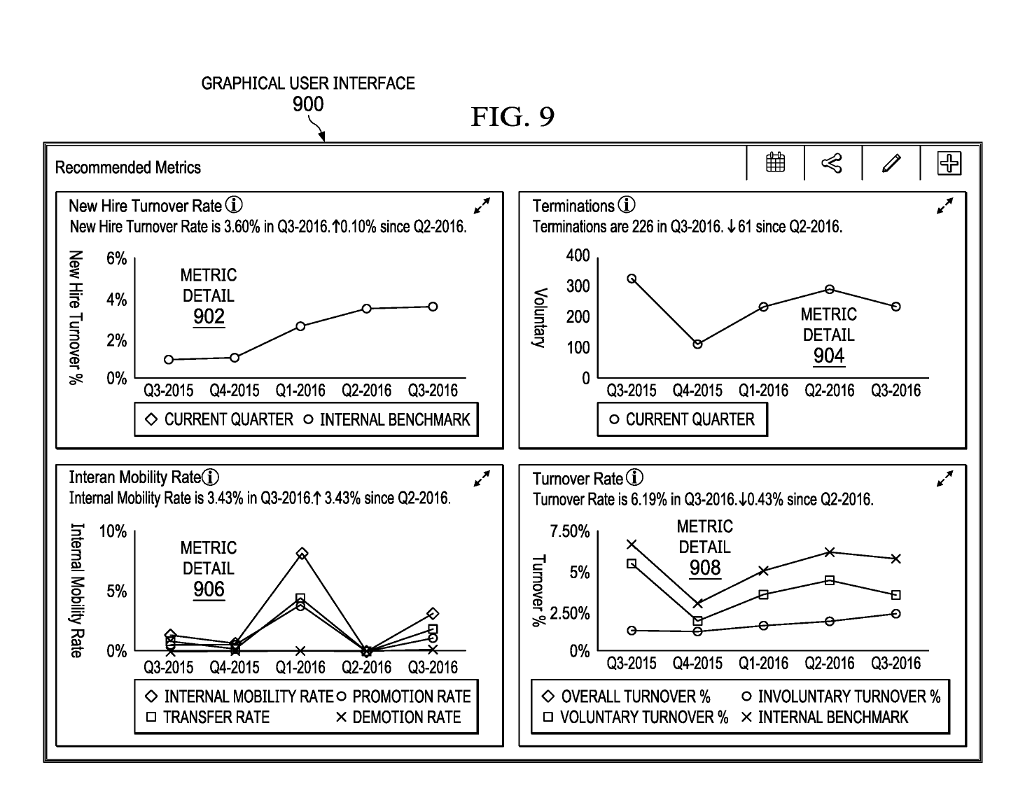

Turning now to FIG. 9, a graphical user interface for displaying metric details of a human resource competitive model is depicted in accordance with an illustrative embodiment. In this illustrative example, graphical user interface 900 can display one or more of metric detail 902, metric detail 904, metric detail 906, and metric detail 908 in response to a selection of a corresponding one of metric comparisons 812 of FIG. 8.

Metric detail 902 displays details for a new hire turnover rate of an organization, such as organization 106 shown in block form in FIG. 1. Metric detail 902 can be displayed in response to a user selection of the new hire turnover rate of metric comparisons 812 of FIG. 8.

Metric detail 904 displays terminations by an organization, such as organization 106. Metric detail 904 can be displayed in response to a user selection of the termination metric of metric comparisons 812.

Metric detail 906 displays an internal mobility rate of employees within an organization, such as organization 106. Metric detail 906 can be displayed in response to a user selection of the internal mobility rate metric of metric comparisons 812.

Metric detail 908 displays a turnover rate of employees within an organization, such as organization 106. Metric detail 908 can be displayed in response to a user selection of the turnover rate metric of metric comparisons 812.

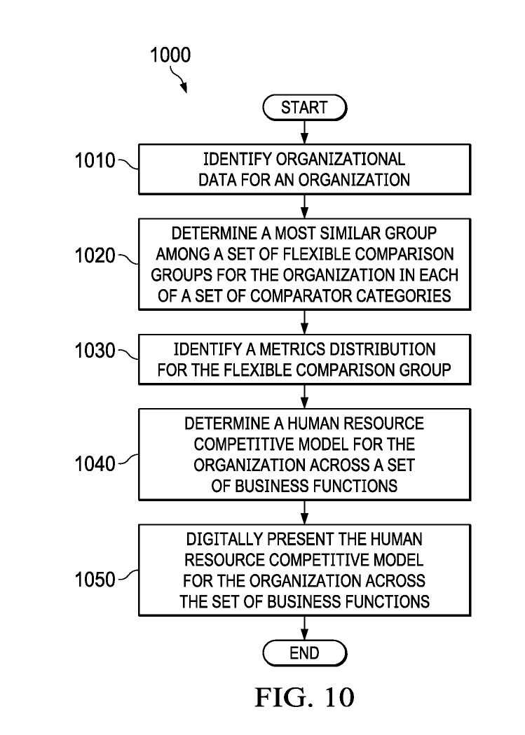

Turning next to FIG. 10, an illustration of a flowchart of a process for digitally presenting a human resource competitive model for an organization is depicted in accordance with an illustrative embodiment. Process 1000 may be implemented in computer system 122, shown in block form in FIG. 1. For example, process 600 may be implemented as operations performed by human resource modeler 118, shown in block form in FIG. 1.

The process begins by identifying organizational data for an organization (step 1010). The organizational data can be, for example, organizational data 105 for organization 106, both shown in block form in FIG. 1. The organizational data includes business metrics for the organization. The business metrics can be, for example, business metrics 126, shown in block form in FIG. 1.

The process determines a most similar group among a set of flexible comparison groups for the organization in each of set of comparator categories (step 1020). The most similar group can be, for example, most similar group 136 among flexible comparison groups 130, both shown in block form in FIG. 1. The set of comparator categories can be, for example, set of comparator categories 132, shown in block form in FIG. 1. The most similar group can be determined by applying a set of comparison models to the organizational data. The set of comparison models can be, for example, comparison models 128, shown in block form in FIG. 1. Each of the set of comparator categories comprises a set of flexible comparison groups.

The process then identifies a metrics distribution for the flexible comparison group (step 1030). The metrics distribution can be, for example, metrics distribution 134, shown in block form in FIG. 1. The metrics distribution can be identified based on a subset of benchmark organizations, such as subset 142 of benchmark organizations 140, both shown in block form in FIG. 1. The subset of benchmark organizations has been grouped into the flexible comparison group.

The process then determines a human resource competitive model for the organization across a set of business functions (step 1040). The human resource competitive model can be, for example, human resource competitive model 124, shown in block form in FIG. 1. The set of business functions can be, for example, set of business functions 112, shown in block form in FIG. 1. The human resource competitive model can be determined by comparing business metrics for the organization to the metrics distribution for the flexible comparison group.

The process then digitally presents the human resource competitive model for the organization across the set of business functions (step 1050), with the process terminating thereafter. In this manner, process 1000 enables operations to be performed consistent with the human resource competitive model.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

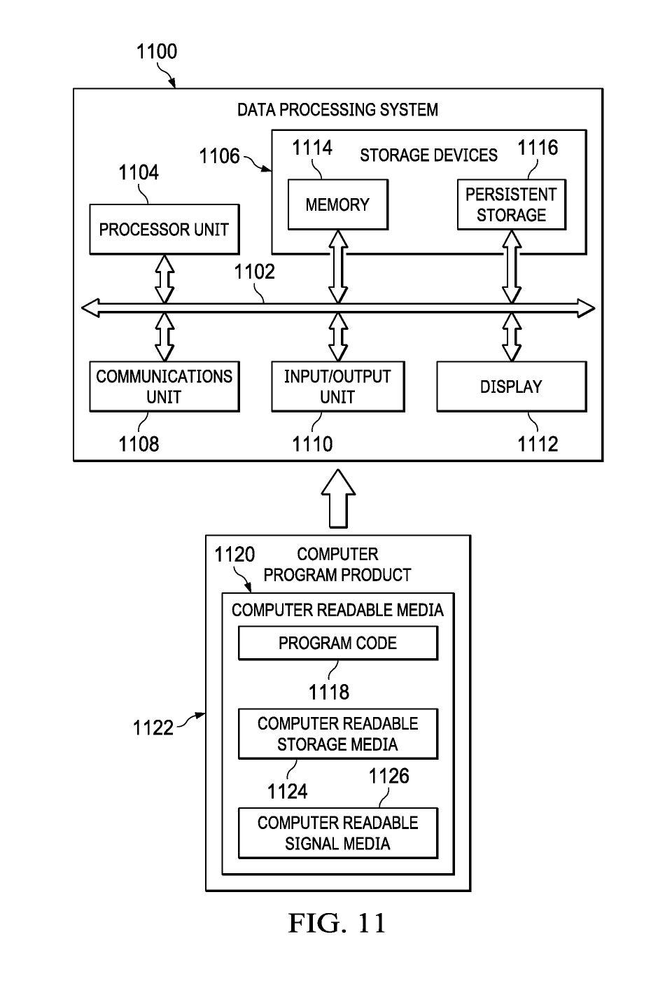

Turning now to FIG. 11, an illustration of a block diagram of a data processing system is depicted in accordance with an illustrative embodiment. Data processing system 1100 may be used to implement one or more computers and computer system 122 in FIG. 1. In this illustrative example, data processing system 1100 includes communications framework 1102, which provides communications between processor unit 1104, memory 1114, persistent storage 1116, communications unit 1108, input/output unit 1110, and display 1112. In this example, communications framework 1102 may take the form of a bus system.

Processor unit 1104 serves to execute instructions for software that may be loaded into memory 1114. Processor unit 1104 may be a number of processors, a multi-processor core, or some other type of processor, depending on the particular implementation.

Memory 1114 and persistent storage 1116 are examples of storage devices 1106. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1106 may also be referred to as computer-readable storage devices in these illustrative examples. Memory 1114, in these examples, may be, for example, a random access memory or any other suitable volatile or non-volatile storage device. Persistent storage 1116 may take various forms, depending on the particular implementation.

For example, persistent storage 1116 may contain one or more components or devices. For example, persistent storage 1116 may be a hard drive, a flash memory, a rewritable optical disk, a rewritable magnetic tape, or some combination of the above. The media used by persistent storage 1116 also may be removable. For example, a removable hard drive may be used for persistent storage 1116.

Communications unit 1108, in these illustrative examples, provides for communications with other data processing systems or devices. In these illustrative examples, communications unit 1108 is a network interface card.

Input/output unit 1110 allows for input and output of data with other devices that may be connected to data processing system 1100. For example, input/output unit 1110 may provide a connection for user input through at least of a keyboard, a mouse, or some other suitable input device. Further, input/output unit 1110 may send output to a printer. Display 1112 provides a mechanism to display information to a user.

Instructions for at least one of the operating system, applications, or programs may be located in storage devices 1106, which are in communication with processor unit 1104 through communications framework 1102. The processes of the different embodiments may be performed by processor unit 1104 using computer-implemented instructions, which may be located in a memory, such as memory 1114.

These instructions are referred to as program code, computer-usable program code, or computer-readable program code that may be read and executed by a processor in processor unit 1104. The program code in the different embodiments may be embodied on different physical or computer-readable storage media, such as memory 1114 or persistent storage 1116.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118. Alternatively, program code 1118 may be transferred to data processing system 1100 using computer-readable signal media 1126.

Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

Thus, the illustrative embodiments provide a method, apparatus, and computer program product for digitally presenting a potentially competitive resource allocation for an organization. Performing operations 114 in a manner that is consistent with a relevant one of subset 142 may allow organization 106 to achieve business metrics 126 similar to benchmark metrics 144. Additionally, human resource competitive model 124 allows organization 106 to perform operations 114 in a manner that may be inconsistent with a relevant one of subset 142 of benchmark organizations 140 based on identified ones of benchmark metrics 144 of subset 142. Performing operations 114 in a manner that is inconsistent with a relevant one of subset 142 may allow organization 106 to achieve business metrics 126 different from benchmark metrics 144.

In this manner, the use of human resource modeler 118 has a technical effect of determining human resource competitive model 124 based on benchmark metrics 144 of a relevant one of subset 142 of benchmark organizations 140, thereby reducing time, effort, or both in the performance of operations 114 supporting set of business functions 112. In this manner, operations 114 performed for organization 106 may be performed more efficiently as compared to currently used systems that do not include human resource modeler 118. For example, operations 114 such as, but not limited to, at least one of hiring, benefits administration, payroll, performance reviews, forming teams for new products, assigning research projects, or other suitable operations for organization 106, performed in a manner that is consistent with a relevant one of subset 142 may allow organization 106 to achieve business metrics 126 similar to benchmark metrics 144.

As a result, computer system 122 operates as a special purpose computer system in which human resource modeler 118 in computer system 122 enables determining of human resource competitive model 124 from organizational data 105 and benchmark metrics 144 based on one or more of comparison models 128. For example, human resource modeler 118 uses comparison models 128 to cluster benchmark organizations 140 into flexible comparison groups 130 corresponding to set of comparator categories 132. Human resource modeler 118 determines corresponding ones of flexible comparison groups 130 for each comparator category 138 of set of comparator categories 132 by clustering benchmark organizations 140 into one or more of subset 142 based on benchmark metrics 144 for benchmark organizations 140. Human resource modeler 118 determines metrics distribution 134 based on benchmark metrics 144 of subset 142.

Human resource modeler 118 compares business metrics 126 for organization 106 to metrics distribution 134 to determine human resource competitive model 124 for organization 106. When human resource competitive model 124 is determined in this manner, human resource competitive model 124 may be relied upon to perform operations 114 for organization 106 in a manner that may allow organization 106 to achieve business metrics 126 similar to benchmark metrics 144.

Thus, human resource modeler 118 transforms computer system 122 into a special purpose computer system as compared to currently available general computer systems that do not have human resource modeler 118. Currently used general computer systems do not reduce the time or effort needed to determine human resource competitive model 124 based on organizational data 105 and benchmark metrics 144 of a relevant one of subset 142 of benchmark organizations 140. Further, currently used general computer systems do not provide for determining human resource competitive model 124 based on comparison models 128.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for digitally presenting a human resource competitive model for an organization, the method comprising:
identifying, by a computer system, organizational data for the organization, wherein the organizational data includes business metrics for the organization;
determining, by the computer system, a most similar group among a set of flexible comparison groups for the organization in each of a set of comparator categories by applying a set of comparison models to the organizational data, wherein each of the set of comparator categories comprises a set of flexible comparison groups;
identifying, by the computer system, a metrics distribution for the flexible comparison group based on benchmark metrics for a subset of benchmark organizations, wherein the subset of benchmark organizations has been grouped into the flexible comparison group;
comparing, by the computer system, the business metrics for the organization to the metrics distribution for the flexible comparison group to determine a human resource competitive model for the organization across a set of business functions; and
digitally presenting, by the computer system, the human resource competitive model for the organization across the set of business functions.

2. The method of claim 1, wherein:
the set of comparator categories comprises a talent competitor category, a peer group category, and an industry category; and
the set of comparison models comprises a talent competitor model, a peer group model, and an industry model;
wherein determining the flexible comparison group for the organization in each of the set of comparator categories further comprises:
determining a talent competitor comparison group by applying the talent competitor model to the organizational data;
determining a peer comparison group by applying the peer group model to the organizational data; and
determining an industry comparison group by applying an industry competitor model to the organizational data.

3. The method of claim 2, wherein determining the talent competitor comparison group for the organization further comprises:
constructing, by the computer system, a sparse matrix of talent competitors from organizational data of the organization, aggregated social data for employees of the organization, organizational data of the subset of benchmark organizations, and aggregated social data for employees of the subset of benchmark organizations;
clustering the talent competitors into a set of clusters based on a cluster analysis of benchmark metrics for the talent competitors, wherein each of the talent competitor comparison groups is represented by one of the set of clusters; and
determining a most similar group for the organization based on a cluster analysis of business metrics for the organization, wherein the most similar group for the organization corresponds to a most similar cluster among the set of clusters.

4. The method of claim 2, wherein determining the peer comparison group for the organization further comprises:
clustering the benchmark organizations into a set of clusters based on a cluster analysis of organizational data for the benchmark organizations and geolocations for the benchmark organizations, wherein each of the peer comparison groups is represented by one of the set of clusters; and
determining a most similar group for the organization based on a cluster analysis of organizational data for the organization, wherein the most similar group for the organization corresponds to a most similar cluster among the set of clusters.

5. The method of claim 4, wherein employee data comprises:
human resources information, payroll information, managerial indicators, and non-managerial indicators.

6. The method of claim 5, wherein the human resources information comprises:
an employee information report of the employee, a standard occupational classification of the employee, a job title of the employee, a North American Industry Classification System class of the employee, a salary grade of the employee, and age of the employee, and a tenure of the employee at the organization, wherein the payroll information comprises:
an annual base salary of the employee; a bonus ratio of the employee; and overtime pay of the employee, wherein the managerial indicators comprise:
a specific managerial indication, a reporting hierarchy of the organization, a manager level description, and the employee information report of the employee, and wherein the non-managerial indicators comprise:
the specific managerial indication, the reporting hierarchy of the organization, the manager level description, the employee information report of the employee, the standard occupational classification of the employee, the annual base salary of the employee, and a bonus ratio of the employee.

7. The method of claim 2, wherein determining the industry comparison group for the organization further comprises:
determining the industry comparison group for the organization based on an industry identifier within the organizational data, wherein each industry comparison group of the industry category have a common industry identifier.

8. The method of claim 1, wherein the business metrics for the organization are human capital management metrics comprising:
attrition metrics, stability and experience metrics, employee equity metrics, organization metrics, workforce metrics, and compensation metrics.

9. The method of claim 8, wherein the attrition metrics are selected from:
a New Hire Turnover Rate metric, a Terminations metric, a Termination Reasons metric, a Hires metric, a Turnover Rate metric, and a Retention metric, wherein the stability and experience metrics are selected from:
a Retirement metric, a Retirement Eligibility metric, an Average Retirement Age metric, a Headcount by Age metric, a Headcount by Generation metric, and a Projected Retirement metric, wherein the employee equity metrics are selected from:
a Female % metric, an Average Age metric, and a Minority Headcount metric, wherein the organization metrics are selected from:
an Average Time to Promotion metric, a Comp-a-Ratio metric, a Headcount by Tenure metric, an Internal Mobility metric, a Span of Control metric, a Comp-a-ratio v Performance metric, and an Average Tenure metric, wherein the workforce metrics are selected from:
a Leave Percentage metric, a Part Time Headcount metric, a Temporary Employee Headcount metric, an Absence metric, an Absences to Overtime metric, a Labor Cost metric, a Leave Hours metric, a Non-Productive Time metric, a Competency Gap metric, and a Strongest Weakest Competency metric, and wherein the compensation metrics are selected from:
an Earnings per full time employee metric, an Earnings metric, an Overtime Cost metric, an Average Earnings metric, a Benefits Cost metric, a Benefits Enrollment metric, a Benefit Contribution metric, and an Overtime Pay metric.

10. The method of claim 1, wherein the set of business functions comprises an accounting and finance function, and administration function, a communications function, a consulting function, a human resources function, and information technology function, a legal function, a logistics and distribution function, a marketing and sales function, and operations function, a product development function, a services function, and a supports function.

11. The method of claim 1, further comprising:
performing an operation for the organization based on competitive resource allocation for the organization, wherein the operation is enabled based on the competitive resource allocation for the organization.

12. The method of claim 11, wherein the operation is selected from hiring operations, benefits administration operations, payroll operations, performance review operations, forming teams for new products, and assigning research projects.

13. A computer system comprising:
a display system; and
a human resource modeler in communication with the display system, wherein the human resource modeler is configured:
to identify organizational data for the organization, wherein the organizational data includes business metrics for the organization;
to determine a most similar group among a set of flexible comparison groups for the organization in each of a set of comparator categories by applying a set of comparison models to the organizational data, wherein each of the set of comparator categories comprises a set of flexible comparison groups;
to identify a metrics distribution for the flexible comparison group based on benchmark metrics for a subset of benchmark organizations, wherein the subset of benchmark organizations has been grouped into the flexible comparison group;
to compare the business metrics for the organization to the metrics distribution for the flexible comparison group to determine a human resource competitive model for the organization across a set of business functions; and
to digitally present the human resource competitive model for the organization across the set of business functions.

14. The computer system of claim 13, wherein:
the set of comparator categories comprises a talent competitor category, a peer group category, and an industry category; and
the set of comparison models comprises a talent competitor model, a peer group model, and an industry model;
wherein determining the flexible comparison group for the organization in each of the set of comparator categories further comprises:
determining a talent competitor comparison group by applying the talent competitor model to the organizational data;
determining a peer comparison group by applying the peer group model to the organizational data; and
determining an industry comparison group by applying an industry competitor model to the organizational data.

15. The computer system of claim 14, wherein in determining the talent competitor comparison group for the organization, the human resource modeler is further configured:
to construct a sparse matrix of talent competitors from organizational data of the organization, aggregated social data for employees of the organization, organizational data of the subset of benchmark organizations, and aggregated social data for employees of the subset of benchmark organizations;
to cluster the talent competitors into a set of clusters based on a cluster analysis of benchmark metrics for the talent competitors, wherein each of the talent competitor comparison groups is represented by one of the set of clusters; and
to determine a most similar group for the organization based on a cluster analysis of business metrics for the organization, wherein the most similar group for the organization corresponds to a most similar cluster among the set of clusters.

16. The computer system of claim 14, wherein in determining the peer comparison group for the organization, the human resource modeler is further configured:
to cluster the benchmark organizations into a set of clusters based on a cluster analysis of organizational data for the benchmark organizations and geolocations for the benchmark organizations, wherein each of the peer comparison groups is represented by one of the set of clusters; and
to determine a most similar group for the organization based on a cluster analysis of organizational data for the organization, wherein the most similar group for the organization corresponds to a most similar cluster among the set of clusters.

17. The computer system of claim 16, wherein employee data comprises:
human resources information, payroll information, managerial indicators, and non-managerial indicators.

18. The computer system of claim 17, wherein the human resources information comprises:
an employee information report of the employee, a standard occupational classification of the employee, a job title of the employee, a North American Industry Classification System class of the employee, a salary grade of the employee, and age of the employee, and a tenure of the employee at the organization, wherein the payroll information comprises:
an annual base salary of the employee; a bonus ratio of the employee; and overtime pay of the employee, wherein the managerial indicators comprise:
a specific managerial indication, a reporting hierarchy of the organization, a manager level description, and the employee information report of the employee, and wherein the non-managerial indicators comprise:
the specific managerial indication, the reporting hierarchy of the organization, the manager level description, the employee information report of the employee, the standard occupational classification of the employee, the annual base salary of the employee, and a bonus ratio of the employee.

19. The computer system of claim 14, wherein in determining the industry comparison group for the organization, the human resource modeler is further configured:
to determine the industry comparison group for the organization based on an industry identifier within the organizational data, wherein each industry comparison group of the industry category have a common industry identifier.

20. The computer system of claim 13, wherein the business metrics for the organization are human capital management metrics comprising:
attrition metrics, stability and experience metrics, employee equity metrics, organization metrics, workforce metrics, and compensation metrics.

21. The computer system of claim 20, wherein the attrition metrics are selected from:
a New Hire Turnover Rate metric, a Terminations metric, a Termination Reasons metric, a Hires metric, a Turnover Rate metric, and a Retention metric, wherein the stability and experience metrics are selected from:
a Retirement metric, a Retirement Eligibility metric, an Average Retirement Age metric, a Headcount by Age metric, a Headcount by Generation metric, and a Projected Retirement metric, wherein the employee equity metrics are selected from:
a Female % metric, an Average Age metric, and a Minority Headcount metric, wherein the organization metrics are selected from:
an Average Time to Promotion metric, a Comp-a-Ratio metric, a Headcount by Tenure metric, an Internal Mobility metric, a Span of Control metric, a Comp-a-ratio v Performance metric, and an Average Tenure metric, wherein the workforce metrics are selected from:
a Leave Percentage metric, a Part Time Headcount metric, a Temporary Employee Headcount metric, an Absence metric, an Absences to Overtime metric, a Labor Cost metric, a Leave Hours metric, a Non-Productive Time metric, a Competency Gap metric, and a Strongest Weakest Competency metric, and wherein the compensation metrics are selected from:
an Earnings per full time employee metric, an Earnings metric, an Overtime Cost metric, an Average Earnings metric, a Benefits Cost metric, a Benefits Enrollment metric, a Benefit Contribution metric, and an Overtime Pay metric.

22. The computer system of claim 13, wherein the set of business functions comprises an accounting and finance function, and administration function, a communications function, a consulting function, a human resources function, and information technology function, a legal function, a logistics and distribution function, a marketing and sales function, and operations function, a product development function, a services function, and a supports function.

23. The computer system of claim 13, wherein the human resource modeler is further configured:
to perform an operation for the organization based on competitive resource allocation for the organization, wherein the operation is enabled based on the competitive resource allocation for the organization.

24. The computer system of claim 23, wherein the operation is selected from hiring operations, benefits administration operations, payroll operations, performance review operations, forming teams for new products, and assigning research projects.

25. A computer program product for digitally presenting a human resource competitive model for an organization, the computer program product comprising:
a computer readable storage media;
program code, stored on the computer readable storage media, for identifying organizational data for the organization, wherein the organizational data includes business metrics for the organization;
program code, stored on the computer readable storage media, for determining a most similar group among a set of flexible comparison groups for the organization in each of a set of comparator categories by applying a set of comparison models to the organizational data, wherein each of the set of comparator categories comprises a set of flexible comparison groups;
program code, stored on the computer readable storage media, for identifying a metrics distribution for the flexible comparison group based on benchmark metrics for a subset of benchmark organizations, wherein the subset of benchmark organizations has been grouped into the flexible comparison group;
program code, stored on the computer readable storage media, for comparing the business metrics for the organization to the metrics distribution for the flexible comparison group to determine a human resource competitive model for the organization across a set of business functions; and
program code, stored on the computer readable storage media, for digitally presenting the human resource competitive model for the organization across the set of business functions.

26. The computer program product of claim 25, wherein:
the set of comparator categories comprises a talent competitor category, a peer group category, and an industry category; and
the set of comparison models comprises a talent competitor model, a peer group model, and an industry model;
wherein the program code for determining the flexible comparison group for the organization in each of the set of comparator categories further comprises:
program code, stored on the computer readable storage media, for determining a talent competitor comparison group by applying the talent competitor model to the organizational data;
program code, stored on the computer readable storage media, for determining a peer comparison group by applying the peer group model to the organizational data; and
program code, stored on the computer readable storage media, for determining an industry comparison group by applying an industry competitor model to the organizational data.

27. The computer program product of claim 26, wherein the program code for determining the talent competitor comparison group for the organization further comprises:
program code, stored on the computer readable storage media, for constructing a sparse matrix of talent competitors from organizational data of the organization, aggregated social data for employees of the organization, organizational data of the subset of benchmark organizations, and aggregated social data for employees of the subset of benchmark organizations;
program code, stored on the computer readable storage media, for clustering the talent competitors into a set of clusters based on a cluster analysis of benchmark metrics for the talent competitors, wherein each of the talent competitor comparison groups is represented by one of the set of clusters; and
program code, stored on the computer readable storage media, for determining a most similar group for the organization based on a cluster analysis of business metrics for the organization, wherein the most similar group for the organization corresponds to a most similar cluster among the set of clusters.

28. The computer program product of claim 26, wherein the program code for determining the peer comparison group for the organization further comprises:
program code, stored on the computer readable storage media, for clustering the benchmark organizations into a set of clusters based on a cluster analysis of organizational data for the benchmark organizations and geolocations for the benchmark organizations, wherein each of the peer comparison groups is represented by one of the set of clusters; and
program code, stored on the computer readable storage media, for determining a most similar group for the organization based on a cluster analysis of organizational data for the organization, wherein the most similar group for the organization corresponds to a most similar cluster among the set of clusters.

29. The computer program product of claim 28, wherein employee data comprises:
human resources information, payroll information, managerial indicators, and non-managerial indicators.

30. The computer program product of claim 29, wherein the human resources information comprises:
an employee information report of the employee, a standard occupational classification of the employee, a job title of the employee, a North American Industry Classification System class of the employee, a salary grade of the employee, and age of the employee, and a tenure of the employee at the organization, wherein the payroll information comprises:
an annual base salary of the employee; a bonus ratio of the employee; and overtime pay of the employee, wherein the managerial indicators comprise:
a specific managerial indication, a reporting hierarchy of the organization, a manager level description, and the employee information report of the employee, and wherein the non-managerial indicators comprise:
the specific managerial indication, the reporting hierarchy of the organization, the manager level description, the employee information report of the employee, the standard occupational classification of the employee, the annual base salary of the employee, and a bonus ratio of the employee.

31. The computer program product of claim 26, wherein the program code for determining the industry comparison group for the organization further comprises:
program code, stored on the computer readable storage media, for determining the industry comparison group for the organization based on an industry identifier within the organizational data, wherein each industry comparison group of the industry category have a common industry identifier.

32. The computer program product of claim 25, wherein the business metrics for the organization are human capital management metrics comprising:
attrition metrics, stability and experience metrics, employee equity metrics, organization metrics, workforce metrics, and compensation metrics.

33. The computer program product of claim 32, wherein the attrition metrics are selected from:
a New Hire Turnover Rate metric, a Terminations metric, a Termination Reasons metric, a Hires metric, a Turnover Rate metric, and a Retention metric, wherein the stability and experience metrics are selected from:
a Retirement metric, a Retirement Eligibility metric, an Average Retirement Age metric, a Headcount by Age metric, a Headcount by Generation metric, and a Projected Retirement metric, wherein the employee equity metrics are selected from:
a Female % metric, an Average Age metric, and a Minority Headcount metric, wherein the organization metrics are selected from:
an Average Time to Promotion metric, a Comp-a-Ratio metric, a Headcount by Tenure metric, an Internal Mobility metric, a Span of Control metric, a Comp-a-ratio v Performance metric, and an Average Tenure metric, wherein the workforce metrics are selected from:
a Leave Percentage metric, a Part Time Headcount metric, a Temporary Employee Headcount metric, an Absence metric, an Absences to Overtime metric, a Labor Cost metric, a Leave Hours metric, a Non-Productive Time metric, a Competency Gap metric, and a Strongest Weakest Competency metric, and wherein the compensation metrics are selected from:
an Earnings per full time employee metric, an Earnings metric, an Overtime Cost metric, an Average Earnings metric, a Benefits Cost metric, a Benefits Enrollment metric, a Benefit Contribution metric, and an Overtime Pay metric.

34. The computer program product of claim 25, wherein the set of business functions comprises an accounting and finance function, and administration function, a communications function, a consulting function, a human resources function, and information technology function, a legal function, a logistics and distribution function, a marketing and sales function, and operations function, a product development function, a services function, and a supports function.

35. The computer program product of claim 25, further comprising:
program code, stored on the computer readable storage media, for performing an operation for the organization based on competitive resource allocation for the organization, wherein the operation is enabled based on the competitive resource allocation for the organization.

36. The computer program product of claim 35, wherein the operation is selected from hiring operations, benefits administration operations, payroll operations, performance review operations, forming teams for new products, and assigning research projects.
